(19) United States
(12) Patent Application Publication
(10) Pub. No.: US 2007/0288755 A1
(43) Pub. Date: Dec. 13, 2007

(54) Method and apparatus for identifying internet registrants

(75) Inventor: James E. Bryant, Marblehead, MA (US)

Correspondence Address: Kirkpatrick & Lockhart Preston Gates Ellis LLP;(FORMERLY KIRKPATRICK & LOCKHART NICHOLSON GRAHAM), STATE STREET FINANCIAL CENTER, One Lincoln Street, BOSTON, MA, 02111-2950, US

(73) Assignee: Trajectoire, Inc., Marblehead, MA (US)

(21) Appl. No.: 11/449,911

(22) Filed: Jun. 9, 2006

(51) Int. Cl. H04K 1/00; H04L 9/00

(52) U.S. Cl. 713/182

(57) ABSTRACT

The present invention relates to a method of verifying identity of a registrant by an application provider. In one embodiment the method includes the steps of transmitting by the registrant a request for registration to the application provider; receiving by the application provider the request and transmitting a passcode to the registrant in response thereto; and calling by the registrant the application provider from a phone having a caller identification associated with the registrant; and providing by the registrant the passcode to the application provider. A system of verifying identity of a registrant is also includes the method provided herein.

### FIELD OF THE INVENTION

The invention relates to the field of internet commerce and more particularly to the field of internet identity verification.

### BACKGROUND

The World Wide Web and internet applications have revolutionized communication between people and have exponentially increased the information and resources available to users of such a network. As internet usage continues to proliferate however, there are a number of concerns regarding the access provided by its usage. Particularly, web sites which permit anonymous users to post information pose a particular concern. Such anonymity and easy access to a network fosters an environment in which content of webpages and communication between users is unrestrained and may be utilized in a harassing or fraudulent manner.

This is especially true with web sites that permit users to place personal information on webpages in order to foster social interaction. These pages, which include personal information and web diaries or logs, termed blogs, have grown in popularity over the past few years and now have thousands of readers. The value of the information or blog diminishes if the information or blog can be attributed to an individual who is not the actual author of the information. It is desirous therefore to provide a method and system to verify the identity of the author of information posted on a web site.

Further, many web sites are financed by the fees that the web site charges to permit an advertiser to place an advertisement on the web site. Typically it is the number of visitors to a web site containing an advertisement that determines how much an advertiser pays to have an advertisement on the webpage. Thus, in web sites which attempt to foster social interaction and which are financed by advertising revenue, it is further desirous to provide an incentive to get potential users to register to have their own webpages and provide correct and interesting information and blogs that will induce other visitors to view the webpages.

The present invention addresses both these needs.

### SUMMARY OF THE INVENTION

In one aspect the invention relates to a method of verifying identity of a registrant by an application provider. In one embodiment the method includes the steps of transmitting by the registrant a request for registration to the application provider; receiving by the application provider the request and transmitting a passcode to the registrant in response thereto; and calling by the registrant the application provider from a phone having a caller identification associated with the registrant; and providing by the registrant the passcode to the application provider.

In another embodiment the method further includes the application provider verifying the caller identification of the phone against a publicly available phone listing database. In another embodiment the request for registration includes registrant email address, registrant name, and registrant phone number. In yet another embodiment a surname or the name of the legal entity of the registrant is referenced in the publicly available phone listing database to verify the identity of the registrant. In still yet another embodiment, the identity of the registrant is verified by referencing a network name system.

In one embodiment the registrant provides the passcode to the application provider via telephone to an automatic voice system. In another embodiment the automatic voice system includes a programmable phone answering system that calls a web service via an automated process, such as but not limited to, xml. In yet another embodiment the web service verifies the passcode with the phone caller identification. In still yet another embodiment the method includes the application provider compiling the registrants into a database of registrations.

In another embodiment, application provider may call registrant at the phone having caller identification associated with the registrant to ensure the identification of the phone represented is accurate. Measures such as this provide a safeguard against caller ID spoofing. Additionally, once registered, a registrant may edit their registration information in the registrant database.

Another aspect of the invention is a system for verifying the identity of a registrant by an application provider. In one embodiment, the system includes a means for transmitting by the registrant a request for registration to the application provider; a means for receiving by the application provider the request and transmitting a passcode to the registrant in response thereto; and means for calling the application provider by the registrant and providing the passcode to the application provider wherein the means for calling has a caller identification associated with the registrant. In another embodiment the means for verifying identity of the registrant further includes a means for verifying, by the application provider, the caller identification of the means for calling by referencing the caller identification against a publicly available phone listing database.

Another aspect of the invention is a system for verifying identity of a registrant by an application provider. In one embodiment the system includes a network by which a registrant transmits a request for registration to an application provider; a server for providing access to and transmitting data over the network; an application provider on the network and a phone having a caller identification associated with the registrant. The application provider receives the request for registration and transmits a passcode in response thereto; and; the registrant calls the application provider from the phone and provides the passcode to verify the identity of the registrant.

Another aspect of the invention is a method of inducing a registrant to provide information on a webpage. The method includes the steps of providing a registrant webpage accessible to the registrant; and enabling material of a third party to be displayed on the webpage for a fee paid by the third party. The fee is proportional to an amount of visitor traffic to the webpage; and a portion of the fee is allocated to the registrant.

In an embodiment, the material of a third party is promotional material. The information provided by the registrant on the webpage may include registrant rating items of interest to consumers, such as, but not limited to vendors, service providers, movies, and books. In another embodiment, ratings offered by the registrant are located at another website which provides a link to the webpage of the registrant.

In another embodiment, registrant may create folders on registrant's webpage sorted by categories. In another embodiment, a method of maintaining a list of preferred links of a registrant in a network maintained by an application provider is provided. The method includes the steps of creating a folder by registrant, the folder including active links to third party information. The third party information may be monitoring by the application provider and periodically updated by the application provider as appropriate. In an embodiment, the folder may be populated with items by the application provider; the items meeting certain predetermined criteria selected by the registrant. Such predetermined criteria may include, but is not limited to geographic criteria and vendor category criteria.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIG. 1(a-b) is a flow chart showing an embodiment of a registration process of the present invention;

FIG. 2 is a flow chart showing an embodiment of a registration editing process according to the present invention;

FIG. 3 is a schematic diagram showing an embodiment of the system of the present invention; and

FIG. 4 is a view of an embodiment of a webpage of the present invention.

### DETAILED DESCRIPTION

The present invention includes an application or webpage provider providing a system and method for providing a webpage for a registrant on the internet. Such a webpage may be located at a URL provided by the application provider. Application provider may further provide webpages for a number of registrants, creating a community of registrant webpages, or an online community.

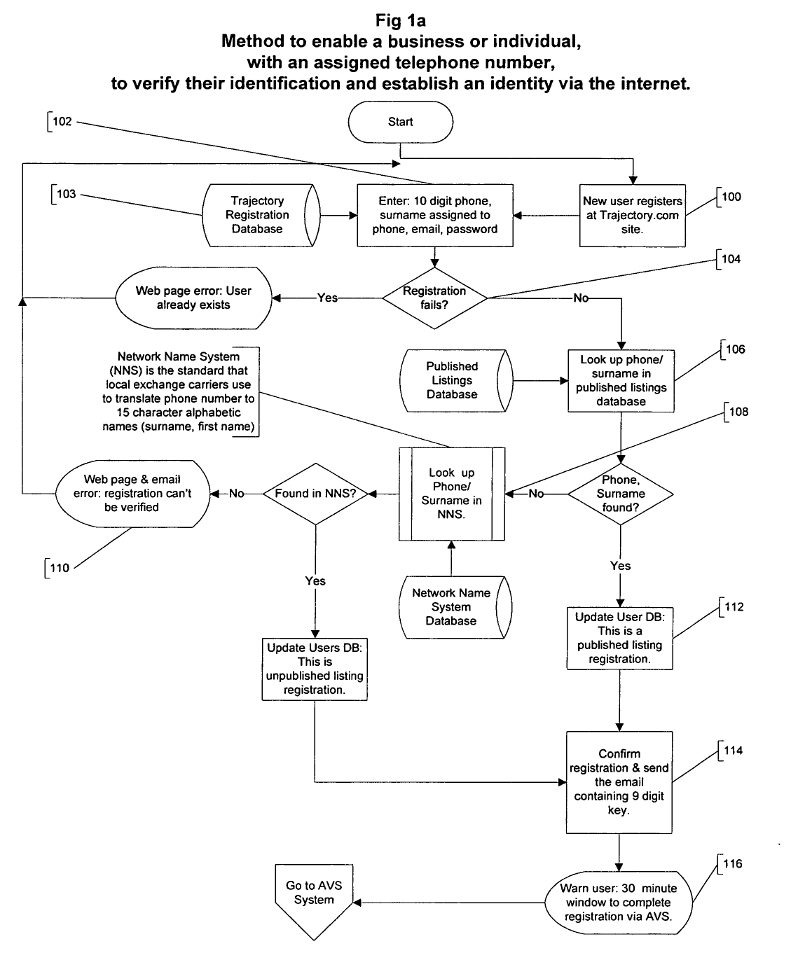

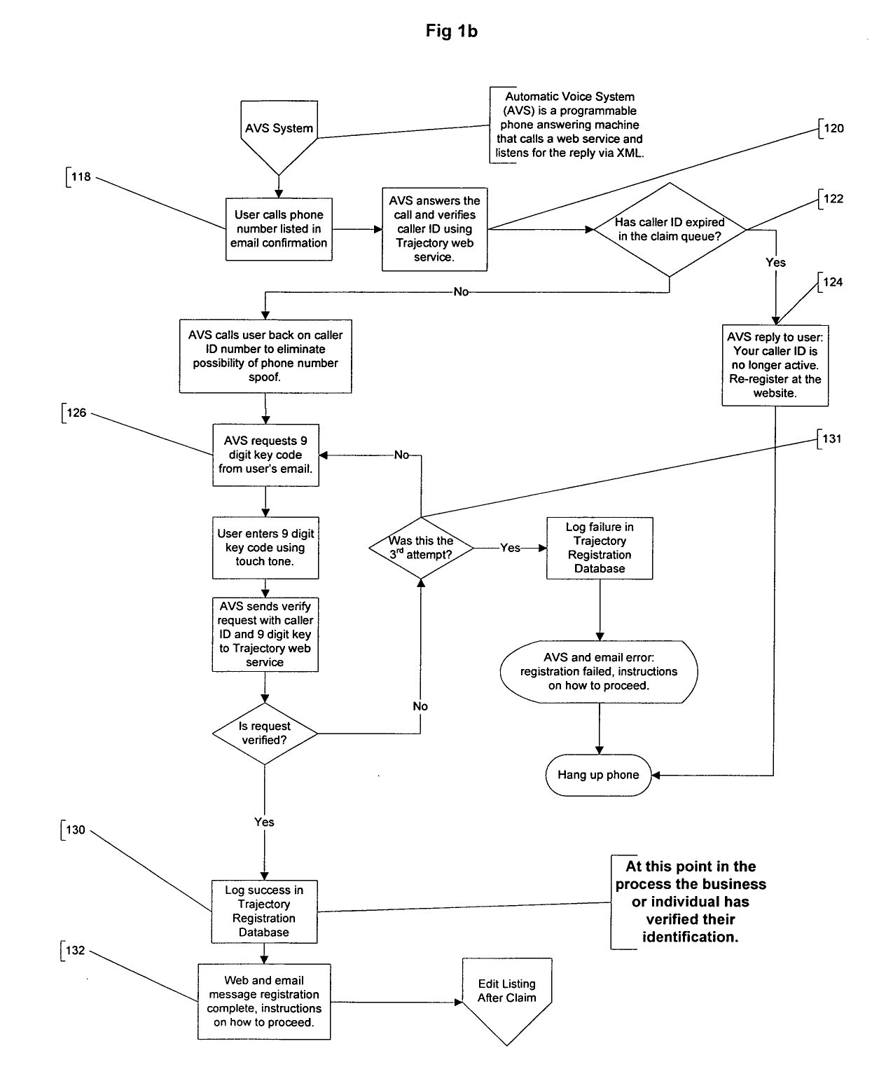

A method to enable a business or individual with an assigned telephone number to verify their identification and establish an identity via the internet is disclosed herein. With reference now to FIG. 1(a-b) of the drawings, initially a business or individual, also known as a registrant, registers certain information at an application provider's website as shown in step 100. Registrant submits (step 102) a ten digit phone number, their surname (if an individual), an email address, and a personal passcode, such as a password. All of this information is submitted to application provider in a request for registration.

Application provider receives registrant's request for registration and determines if the information is currently in the preliminary registration database (step 104). If the registrant's information has already been submitted to application provider, registration fails because the registrant is already registered. If not, registrant is entered into a preliminary registrant database.

Application provider then looks up registrant's phone number in a published listings database to verify registrant and phone listing accuracy and legitimacy as shown in step 106. If a published listing of registrant's surname is not available, application provider looks up registrant's surname in a network name system (step 108). A network name system is the standard that local exchange carriers use to translate phone numbers into 15 character alphabetic names.

If registrant cannot be located in either a published phone listing database or a network name system, registration fails (step 110). If registrant and phone listing are verified in one of the sources, registrant is entered into a second database (step 112). The application provider then sends registrant an email with an application provider generated passcode (step 114). In one embodiment this passcode includes a nine digit key. Also included in the email is a warning from application provider that the registrant is required to complete the registration process within a specified period of time and an elapsed time clock is started.

Upon receipt of the email from application provider, registrant has a predefined time period in which to complete the registration process (step 116). The time period may be chosen at the discretion of the application provider. Completion of registration may take place by registrant calling application provider at a number provided by application provider in an email (step 118). Further, the registrant must call the application provider from a phone with a caller identification number associated with registrant. In one embodiment the caller identification number is also submitted to application provider in registrant's request for registration.

In one embodiment, an automatic voice system (AVS) answers registrant's phone call and verifies the caller identification using the web service (step 120). In one embodiment the automatic voice system is a programmable phone answering machine that calls a web service and listens for the reply via xml. The application provider then determines (step 122) if the predetermined time period has expired by noting the call in time according to the elapsed time clock. If the elapsed time exceeds the predetermined period, the registration period has expired (step 122). If the registration period has expired, the application provider tells registrant that their caller identification is no longer active (step 124). A repeat of the registration process is required for registrant to receive another passcode.

If the passcode has not expired, the automatic voice system requests the application provider generated passcode from registrant (step 126). The registrant the enters the passcode and the AVS then sends a request with the caller identification and the application provider generated passcode to web service for verification (step 128). If the request is verified, the registration is successful; and registrant is logged into trajectory registration database (step 130). A registration email is then sent to registrant with further instructions of use and verification as shown in step 132.

If the request is not verified, and there have been less than a predetermined number of attempts by the registrant (step 131), the AVS requests that the registrant enter the nine digit key code again (126). If the registrant has failed to enter the correct code after a specified number of attempts, the failure is logged (step 134) and the AVS instructs the registrant that the registration has failed and suggests how to proceed (step 136)

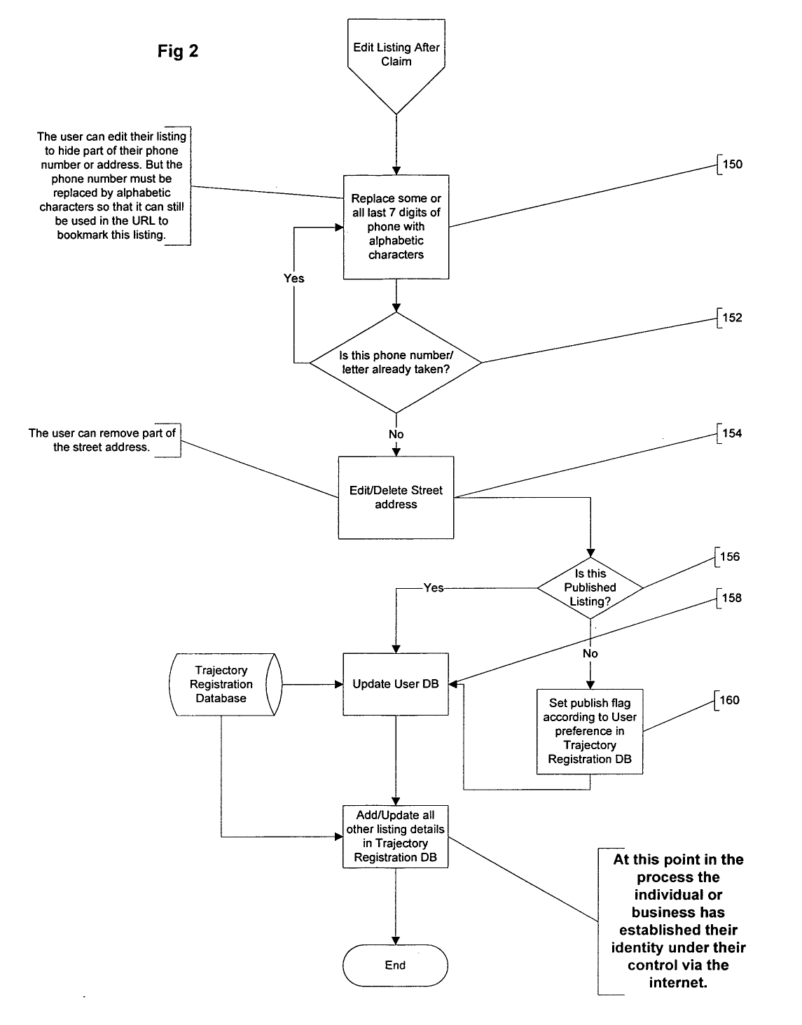

Once registered, registrant may choose to edit their registration information. Referring to FIG. 2, a registrant, for example, can edit their listing to hide part of their phone number or address. For example, the phone number may be replaced by alphabetic characters so that it can be used in an URL string to bookmark their listing. To do this, the registrant replaces some or all of the digits of the phone number with alphabetic characters (step 150). The system then determines if the alphabetic characters chosen are already in use by someone else (step 152). Next the user may modify or remove the street address (step 154) and determine whether this street address is to be published (step 156). If the information is publishable, the database is updated (step 158). If the information is not to be published, a do-not-publish flag attached to the information is set (step 160) indicating the information is not to be published and then the database is updated (step 158).

The application provider further may take measures to prevent caller ID spoofing. Caller ID spoofing is a service that allows a caller to masquerade as someone else by falsifying the number that appears on the recipient's caller ID display; caller ID spoofing can make a call appear to come from any phone number the caller wishes. Several service providers offer caller ID spoofing, including Camophone, Spooftel, and PI Phone. To use Camophone's service, a customer pays in advance for a certain number of calling minutes. To set up a call, the customer opens a Web form and enters their phone number, the recipient's phone number, and the number chosen to appear on the recipient's caller display. Camophone then connects the call through between the caller and recipient phones as stipulated. Some other versions involve the caller dialing a number to access the service and then dialing the phone numbers. Caller ID spoofing has been available for years to people with a specialized digital connection to the telephone company. Collection agencies, law enforcement officials, and private investigators have used the practice, with varying degrees of legality. In order to avoid caller ID spoofing, application provider may call back registrant on the Caller-ID number indicated to ensure the caller identification is accurate and legitimate.

In an embodiment, the system and method of the present invention provide in its aggregate an online directory on the internet of registrants. Registrant names, addresses, telephone numbers, and other registrant information may be listed at registrant's discretion. A directory, as contemplated herein, also may be more comprehensive than known directories, as registrant information may be more complete. Registrants, for example, may be listed by mobile phone numbers, email addresses, voice mailboxes, voice-over-internet protocol (VOIP) number or listings, and other personal verifiable data unique to registrant.

A method of inducing a registrant to provide information on a webpage is also provided herein. The method includes the steps of providing a registrant webpage accessible to the registrant as described above. The method further includes enabling material of a third party to be displayed on the webpage for a fee paid by the third party. The material of a third party to be displayed may be promotional material, including, but not limited to advertisements, testimonials, third party advertisements and referrals. Some examples include advertisements such as banner ads, flash ads, and other internet advertising mechanisms. The fees associated with the various examples just described may be varied according to the advertisement type.

The fee paid by the third party is also proportional to an amount of visitor traffic to the webpage. To induce the registrant to provide information on his or her webpage that is interesting, a portion of the fee paid by the third party is allocated to the registrant. Therefore, the more visitors visit a webpage, the greater the allotment of money is to a registrant, thereby creating tremendous incentive of registrant to attract visitors to their webpage.

The information which application provider uses to entice registrant to provide on their webpage is varied. More generally speaking, the method of inducement is designed to promote use of webpages in application provider's network. The more viewers access a webpage, the more the ads will be displayed on the webpage. This will increase the revenue directed to the registrant associated with the webpage, as funneled through the application provider.

In order to increase traffic on a webpage, a registrant may attract guests with content-related items, including but limited to blogging on various topics of interest, including politics and sports, as well as reviewing and rating items of interest to people and consumers. The reviews and ratings may include, but is not limited to items of geographic local interest, including ratings of local service providers, merchants, public events, public utilities, and local attractions. The review and ratings may also include items with no local geographic significance, such as but not limited to art-related items, such as literature, cinema, music, and television.

The subject matter and content of a registrant's webpage is virtually limitless, and traffic may be further increased by registrant providing links to other webpages, and other webpages in turn providing links to registrant's webpage. Ratings and reviews are particularly suited for this type of cross-referencing, particularly where local municipalities or service providers may reference reviews of local their service providers, or testimonials of their services, respectively. These of course, are just examples of the non-limiting applications of such a webpage and network supported and maintained by application provider. Additionally, content on a registrant's webpage may be sorted categorically, whether by subject matter, geographically, chronologically, or in any manner limited only by the registrant's imagination. Such categories may further be linked from the homepage of a registrant's webpage to folders of a registrant.

In a non-limiting embodiment, application provider also may provide registrant with a system of maintaining a list of preferred links of registrant, on registrant's webpage, or otherwise stored. The system may include creating a folder by a registrant which includes active links to third party information. The system may further include a monitoring system by application provider of the third party information so as to periodically update the active links. In an embodiment, registrant may request that application provider populate a folder based upon a set of criteria established by registrant. Such criteria may include, but is not limited to, geographic criteria, vendor category criteria, subject matter criteria, event-related criteria, and any other criteria limited only by registrant's imagination. Criteria may be geo-spatially designed to certain events in a geographic area, time frame, or content of subject matter of registrant's designation.

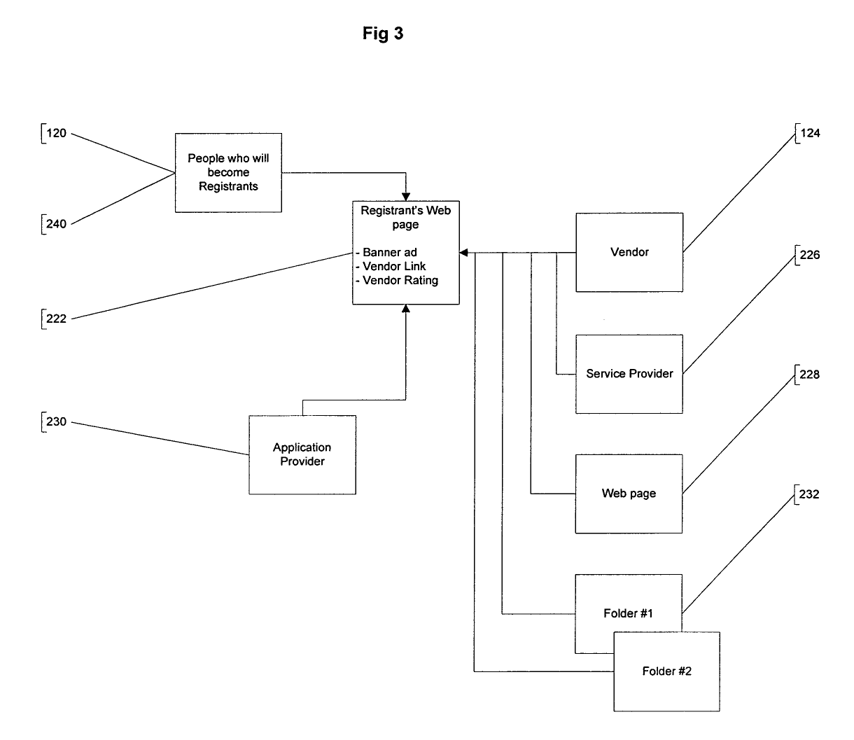

With reference now to FIG. 3, a registrant 220 is shown with a webpage 222. A registrant opens an account with an application provider 230 through a registration system also described herein. People, 240 can access webpage 10 through the internet at a URL address, provided by application provider 230. Webpage 222 includes links to various items, including vendor 224, service provider 226, another webpage 228, and folders of registrant shown at 232.

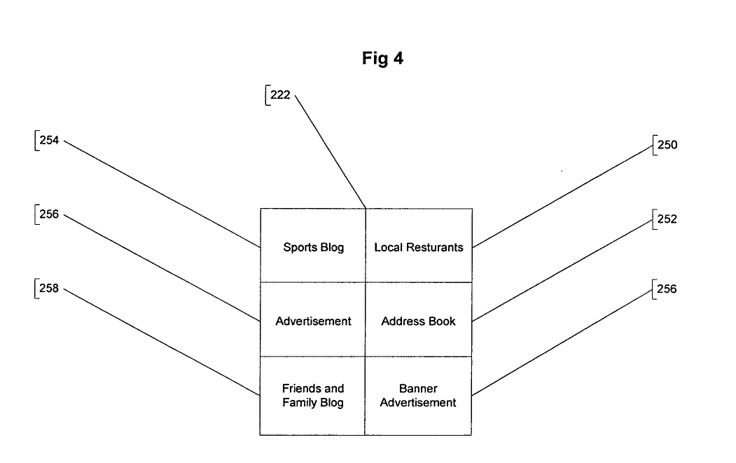

An expanded view of webpage 222 is shown in FIG. 4. As shown, a registrant may utilize his or her webpage in any manner desired by registrant. As an example, an upper right hand corner of webpage 222 may include information on local restaurants, including reviews, information gathered from third party sources, and information from the eating establishments themselves shown in 250. In one embodiment, the restaurant section may include links to personal folders of registrant, third party sources, and direct links to the restaurants themselves. Further sections may include, but is not limited to; address books 252, blogs 254, advertisements 256, and links to URL addresses associated with friends and family of registrant 258, including other registrant webpages.

While the invention has been described in terms of certain exemplary preferred embodiments, it will be readily understood and appreciated by one of ordinary skill in the art that it is not so limited and that many additions, deletions and modifications to the preferred embodiments may be made within the scope of the invention as hereinafter claimed. Accordingly, the scope of the invention is limited only by the scope of the appended claims.

What is claimed is:

1. A method of verifying identity of a registrant by an application provider comprising:
Transmitting by said registrant a request for registration to said application provider;
Receiving by said application provider said request and transmitting a passcode to said registrant in response thereto; and
Calling by said registrant said application provider from a phone having a caller identification associated with said registrant; and providing by said registrant said passcode to said application provider.

2. The method of verifying identity of a registrant of claim 1 further comprising said application provider verifying said caller identification of said phone against a publicly available phone listing database.

3. The method of verifying identity of a registrant of claim 2 wherein said request for registration includes registrant email address, registrant name, and registrant phone number.

4. The method of verifying identity of a registrant of claim 3 wherein a surname of said registrant is referenced in said publicly available phone listing database to verify said identity of said registrant.

5. The method of verifying identity of a registrant of claim 1 wherein said identity of said registrant is verified by referencing a network name system.

6. The method of verifying identity of a registrant of claim 3 wherein said request for registration further comprises an address of said registrant.

7. The method of verifying identity of a registrant of claim 1 further comprising said registrant providing said passcode to said application provider via telephone to an automatic voice system.

8. The method of verifying identity of a registrant of claim 7 wherein said automatic voice system comprises a programmable phone answering system that calls a web service via xml.

9. The method of verifying identity of a registrant of claim 8 wherein said web service verifies said passcode with said phone caller identification.

10. The method of verifying identity of a registrant of claim 1 further comprising the steps of said application provider compiling said registrants into a database of registrations.

11. The method of verifying identity of a registrant of claim 10 further comprising the steps of editing by said registrant information in said database.

12. The method of verifying identity of a registrant of claim 1 further comprising the steps of said application provider calling said registrant at said phone having a caller identification associated with said registrant.

13. A means for verifying the identity of a registrant by an application provider comprising:
A means for transmitting by said registrant a request for registration to said application provider;
A means for receiving by said application provider said request and transmitting a passcode to said registrant in response thereto; and
Means for calling said application provider by said registrant and providing said passcode to said application provider wherein said means for calling has a caller identification associated with said registrant.

14. The means for verifying identity of a registrant of claim 13 further comprising a means for verifying said caller identification of said means for calling by said application provider by referencing said caller identification against a publicly available phone listing database.

15. The means for verifying identity of a registrant of claim 13 further comprising a means for calling a web service via xml by said application provider to verify said passcode with said caller identification.

16. A system for verifying identity of a registrant by an application provider comprising:
A network by which a registrant transmits a request for registration to an application provider;
A server for providing access to and transmitting data over said network;
An application provider on said network, wherein said applicant provider receives said request for registration and transmits a passcode in response thereto; and
A phone having a caller identification associated with said registrant; wherein said registrant calls said application provider from said phone and provides said passcode to verify said identity of said registrant.

17. The system for verifying identity of a registrant of claim 16 further comprising an automatic voice system for receiving calls from said registrant.

18. The system for verifying identity of a registrant of claim 17 wherein said automatic voice system calls a web service via xml to verify said registrant identity with said passcode.

19. A method of inducing a registrant to provide information on a webpage comprising the steps of:
Providing a registrant webpage accessible to said registrant;
Enabling material of a third party to be displayed on said webpage for a fee paid by said third party, said fee proportional to an amount of visitor traffic to said webpage;
Allocating a portion of said fee to said registrant.

20. The method of inducing a registrant to provide information of claim 19 wherein said material is promotional material.

21. The method of inducing a registrant to provide information of claim 19 wherein said information comprises registrant rating items of interest to consumers.

22. The method of inducing a registrant to provide information of claim 21 wherein said registrant ratings are located at another website which provides a link to said webpage of said registrant.

23. The method of inducing a registrant to provide information of claim 21 wherein said items of interest comprise: vendors, service providers, movies, and books.

24. The method of inducing a registrant to provide information of claim 19 wherein said registrant creates folders on said webpage sorted by categories.

25. A method of maintaining a list of preferred links of a registrant in a network maintained by an application provider, the method comprising the steps of:
Creating a folder by a registrant comprising active links to third party information; and
Monitoring by said application provider said third party information to periodically update said active links.

26. The method of maintaining a list of claim 25 wherein said folder is to be populated with items by said application provider; said items meeting certain predetermined criteria selected by said registrant.

27. The method of maintaining a list of claim 26 wherein said predetermined criteria comprises geographic criteria, and vendor category criteria.
